(19) United States
(12) Patent Application Publication
(10) Pub. No.: US 2018/0306341 A1
(43) Pub. Date: Oct. 25, 2018

(54) Solenoid Valve Assembly for Flow Control and Refrigeration System Comprising a Solenoid Valve Assembly for Flow Control

(71) Applicant: Whirlpool S.A., Sao Paulo (BR)

(72) Inventor: Dietmar Erich Bernhard Lilie, Joinville (BR)

(73) Assignee: Whirlpool S.A.

(21) Appl. No.: 15/946,779

(22) Filed: Apr. 6, 2018

(30) Foreign Application Priority Data
Apr. 20, 2017 (BR) 10 2017 008306 3

(51) Int. Cl. F16K 31/06; F02M 63/00; F02M 47/02

(52) U.S. Cl. CPC F16K 31/0627; F02M 63/0078; F16K 31/0606; F02M 2200/08; F02M 63/0021; F02M 47/027; F02M 63/0019

(57) ABSTRACT

A solenoid valve assembly, for flow control, including: a main body and a secondary body; a coil arranged within the main body; at least one inlet path and at least one outlet path; a valve seat physically associated to the main body and to the secondary body; and at least one movable member arranged within the airtight chamber of the valve seat including a lower wall that includes a magnetic conducting portion and a magnetic barrier portion able to deflect the magnetic flux that passes through the lower wall of the valve seat towards the movable member.

### FIELD OF THE INVENTION

The present invention refers to a refrigeration system and, principally, to a valve assembly for flow control in a refrigeration system which is controllable, fast actuation, low electric consumption, high durability and able to provide a gain of efficiency in refrigeration systems.

### FUNDAMENTALS OF THE INVENTION

As known to those skilled in the art, solenoid-controllable valves are widely known and have a wide range of possible applications, especially in fields related to fluid flow regulation, wherein often their fast actuation and accurate control are relevant factors to be considered in the design of these components. Examples of applications of this type of valve are the fuel injection valves of internal combustion engines and refrigeration compressors and/or the refrigeration circuits themselves.

Generally, the solenoid-controllable valves comprise a coil which is formed by a coiled wire, so that when an electric current passes through this wire, said current generates a force of attraction or repulsion, causing the movable portion of the valve is moved toward or away from a channel that is sealing, thereby providing for its opening and/or closing.

In such valves, the actuation response time is given in function of several factors, such as the mass of the movable portion of the valve, the electric current that passes through the coil and, consequently, the dissipated electric power, the design of the air gap, among others.

Solenoid-controllable valves known from the state of the art are basically divided into two groups: those of rotary motion and those of linear motion, most of which are bi-stable (stable in the open position and in the closed position); wherein both depend on a drive sequence, which makes them slow and applicable mainly in solutions that perform a low number of cycles, thus comprising low reliability to operate in a large number of cycles.

In view of this scenario, some solutions of the state of the art are already aimed at the design of a solenoid-controllable valve having a fast actuation, since such a factor, depending on the application in question, may be of paramount importance.

It is mentioned, for example, the solution of document U.S. Pat. No. 4,905,962, which describes about a fast switching electromagnetic solenoid valve which includes an electromagnet comprising a pole surface inclined at an angle towards the valve plate to define a wedge-shaped air gap therebetween, so that the total valve stroke is decreased except in the vicinity of the valve seat (wherein it is defined the channel to be sealed), and consequently so that the acceleration of that valve is optimized at the beginning of the its actuation. In particular, it is further observed that the flux of the magnetic field in the arrangement proposed by this document apparently occurs through the housing and the body defining the pole surface, the shape of which also resembles a wedge. In this way, it can be seen that the aforementioned document, despite providing a fast actuation valve, it does not worry about providing an optimal path for the magnetic flux for purposes of saving electric consumption.

Another solution related to the fast actuation of a solenoid valve is found in document US 2014 225018, which in turn describes a valve assembly comprising a coil accommodated in a main body, a movable member configured to regulate the passage of fluid through a channel, said movable member being physically associated with an armature, said armature having magnetic and non-magnetic parts, wherein the magnetic part of the armature allows this to be attracted and/or repelled when the coil is energized and generates a magnetic field, and also wherein the non-magnetic parts are provided in minimal quantity for fixing the armature together with the main body of the valve assembly so as not to impair the magnetic flux by the armature. Said document, therefore, shows some concern about the path to be traveled by the magnetic flux, so that it is able to attract/repel the movable member of the valve that provides the seal of a certain channel, which is one of the foci to be addressed by the present invention. However, the solution of US 2014 225018 can still be optimized from the point of view of magnetic flux, as well as from the point of view of design, since it does not provide a compact solution, among other reasons.

In parallel, and with reference to the arrangements and constructions of refrigeration systems, specifically, it is pointed out that various possible arrangements are already known from the state of the art. In a simpler arrangement, a refrigeration system is sequentially composed of a compressor which compresses and pumps a working fluid (coolant fluid) through a compression mechanism, a condenser that provides the release of heat by the working fluid, an expansion device (capillary tube, for example) which expands the working fluid, an evaporator, in which the working fluid is vaporized, withdrawing heat from the environment to be cooled, as well as pipes which fluidly connect said devices and define a circuit.

In some refrigeration systems, the expansion device—or capillary tube—is sized for a fixed capacity of the compressor and for a condition of better performance at a single ambient temperature. With the variation of the ambient temperature and/or the internal load of the system, this performance is impaired. In refrigeration systems using variable capacity compressors this problem is even more relevant, since the capillary tube is sized to the maximum capacity of the compressor, and when it works in low capacity the capillary tube has a higher flow than the compressor pumps, causing the efficiency of the system to be reduced.

More specifically, to avoid this problem, some solutions already describe the use of valves that control the flow of coolant fluid within the refrigeration system. One of these solutions is disclosed in the document PI 06012981. Said document describes, in a conceptual manner, a system and method of flow control in refrigeration circuits comprising a hermetic compressor fluidly connected to a closed circuit comprising condenser, evaporator and a fluid expansion device, wherein said fluid expansion device has a nominal expansion capacity and it is positioned between the evaporator and the condenser, and wherein the closed circuit also comprises a nominal capacity of circuit flow. Further, said system comprises a flow control valve which is positioned between an outlet of the condenser and an inlet of the fluid expansion device, wherein the flow control valve is modulated so that the fluid passing through the expansion device of is always substantially in nominal expansion capacity.

Thus, and in view of all of the aforementioned, although the solutions described above prove to be functional for the purposes for which they were made feasible, it is noted that there is still a gap in the state of the art with regard to the provision of a solenoid-controllable flow control valve which is reliable, fast switching, low power consumption, high durability, in a compact and inexpensive arrangement, which is also capable of make feasible the concept of the solution described in the document PI 06012981.

It is from this scenario that the present invention arises.

### OBJECTIVES OF THE INVENTION

Thus, it is the principal objective of the present invention to disclose a solenoid valve assembly for flow control which is reliable, has high durability and, mainly, has low power consumption.

It is also an objective of the present invention to provide a compact and inexpensive solenoid valve assembly.

It is further an objective of the present invention to disclose a solution which is capable of altering the air gap of the solenoid valve assembly in order to define an optimal path for the generated magnetic flux.

Another objective is to describe a simple, inexpensive and high durability solution that is feasible for various applications, including in high efficiency refrigeration systems.

### SUMMARY OF THE INVENTION

The objectives summarized above are fully achieved by means of a solenoid valve assembly for flow control, said solenoid valve assembly including: a main body and a secondary body, a coil arranged within the main body, at least one inlet path and at least one outlet path, a valve seat physically associated to the main body and to the secondary body, in order to perform the interface between these, said valve seat, in combination with at least the secondary body, defining an airtight chamber.

The at least one movable member is arranged within the airtight chamber and it comprises at least one ferromagnetic portion, so as to be attracted or repelled as a function of the magnetic field generated by the coil, so that the movable member is able to move.

Said at least one inlet path communicates with the airtight chamber by at least one inlet opening and said at least one movable member is cooperative with the at least one inlet opening in order to open or close it.

The main body defines an open chamber that is longitudinally spaced from the airtight chamber.

Particularly, according to the present invention, said valve seat comprises a lower wall including a magnetic conducting portion and a magnetic barrier portion, said magnetic barrier portion being able to deflect the magnetic flux that passes through the lower wall of the valve seat towards the movable member.

Preferably, the inlet path is defined in a tubular body that is physically associated to the main body and to the valve seat.

Also, preferably, the magnetic barrier portion is a metallic ring, made of non-ferrous material and, more specifically, of stainless steel. Alternatively, the magnetic barrier portion is an air ring.

According to the present invention, when the coil is de-energized, the movable member is spaced from the inlet opening, so as to maintain fluid communication between the inlet path and the airtight chamber.

The movable member includes a lower face that is capable of sealing the inlet opening and an upper face which is preferably associated with at least one return spring, said at least one return spring being a flat spring or a bundle of flat springs.

Said return spring is seated against a stop defined in a flange portion of the secondary body.

The movable member comprises a discoid body. Furthermore, said movable member further comprises at least one through-hole radially spaced from the at least one inlet path.

In addition, the present invention also refers to a refrigeration system comprising a solenoid valve assembly for flow control, the refrigeration system including at least one compressor, at least one condenser, at least one expansion device, at least one evaporator, a closed circuit which fluidly and sequentially communicates the at least one compressor, the at least one condenser, the at least one expansion device and the at least one evaporator.

Said at least one expansion device comprises a respective nominal expansion capacity and it is positioned between the at least one condenser and the at least one evaporator.

The compressor provides a flow of fluid along the closed circuit, wherein the closed circuit comprises a nominal capacity of circuit flow.

The solenoid valve assembly for flow control is positioned between an outlet of the at least one condenser and an inlet of the at least one expansion device, said solenoid valve assembly being modulated so that the fluid passing through the expansion device is equivalent to the nominal expansion capacity, wherein the solenoid valve assembly for flow control is defined as above.

### BRIEF DESCRIPTION OF THE DRAWINGS

The present invention will be described in detail on the basis of the illustrative figures listed below, wherein:

FIG. 1 illustrates a longitudinal cross-sectional view of a solenoid valve assembly according to the state of the art;

FIG. 2 illustrates a longitudinal cross-sectional view of a solenoid valve assembly according to the preferred embodiment of the present invention;

FIG. 3 schematically illustrates a refrigeration system comprising a solenoid valve assembly in accordance with the present invention.

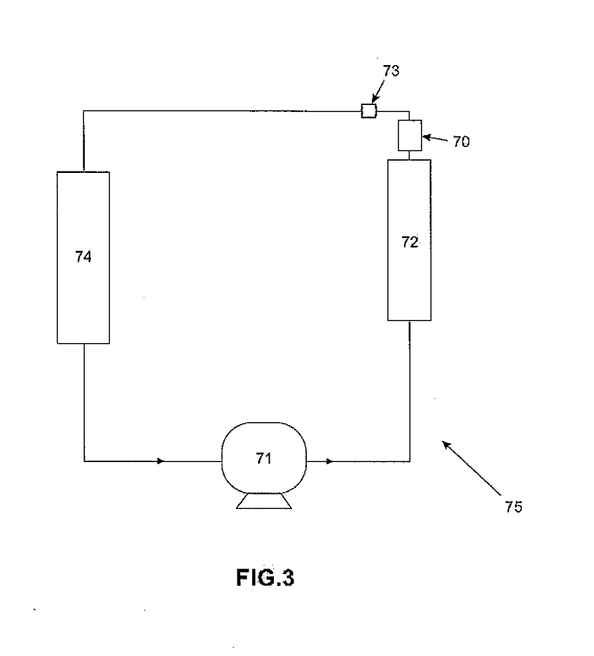

### DETAILED DESCRIPTION OF THE INVENTION

According to the central objectives of the invention in question, it is disclosed a solenoid valve assembly 70 for flow control, which includes a main body 10 defining an open chamber 13 and housing, in its interior, a coil 30, a secondary body 20 which is longitudinally spaced from the main body 10, as well as a valve seat 40 physically associated to the main body 10 and to the secondary body 20, simultaneously, in order to perform the interface between these, said valve seat 40, in combination with at least the secondary body 20, defining an airtight chamber 41 which, obviously, is also longitudinally spaced from the open chamber 13.

The airtight chamber 41 is so named to differentiate it from the open chamber 13—into which the coil 30 is housed—which is defined by the main body 10. Airtight chambers, such as that of the solenoid valve assembly 70 of the present invention, also are already known so that their functionality need not be described in detail. In turn, the open chamber 13 is so named, since it is not necessarily airtight.

It is worth mentioning, however, that said airtight chamber 41 has an important pressure equalizing function, as will be further detailed below.

Inside said airtight chamber 41, it is arranged at least one movable member 42, preferably in discoid shape, which regulates the passage of fluid from at least one inlet path 11 to at least one outlet path 21 through its movement. More specifically, said inlet path 11 communicates with the airtight chamber 41 through at least one inlet opening 12, and the airtight chamber 41 in turn communicates with the outlet path 21 by a plurality of through-holes 43 defined on the movable member 42 and circumferentially spaced from each other.

The at least one movable member 42 cooperates with the at least one inlet opening 12 so as to open or close it upon its attraction or repulsion, as a function of the magnetic field generated by the coil 30, since said movable member 42 comprises at least one ferromagnetic portion.

More specifically, the movable member 42 includes a lower face 421 and an upper face 422, the lower face 421 being that able to seat against the valve seat 40 so as to seal the inlet opening 12. In addition, the stroke of said movable member 42 is, therefore, provided from a lower wall 45 of the valve seat 40 to a flange portion 23 of the secondary body 20.

According to the preferred embodiment of the present invention, when the coil 30 is energized, the movable member 42 is attracted and seals the inlet opening 12, and when the coil 30 is de-energized, the movable member 42 is moved by simple pressure differential, that is, by the fluid force itself from the inlet path 11, and rests against the flange portion 23 of the secondary body 20. In this situation wherein the coil 30 is de-energized, the movable member 42 is spaced from the inlet opening 12 so as to maintain fluid communication between the inlet path 11 and the airtight chamber 41, this being, therefore, its “only stable position”.

A person skilled in the art will also appreciate that, alternatively, the design of the solenoid valve assembly 70 could be adapted to provide the only stable position of the movable member 42 in a closing condition of the inlet opening 12, when the coil 30 was de-energized.

The advantage of having the only stable position of the movable member 42 in an opening condition of the inlet opening 12 is that, in a situation of failure of the solenoid valve assembly 70, the fluid passage would not cease and the upstream pressure of the movable member 42 would not raise too much, so that the integrity of the assembly, despite the failure, would still be maintained.

Particularly, according to the present invention, said valve seat 40 comprises a lower wall 45 which rests against the main body 10, either in a side wall 15 of the latter or in some flange extending therefrom. The lower wall 45 of the valve seat 40 includes a magnetic conducting portion 451 and a magnetic barrier portion 452, said magnetic barrier portion 452 being able to deflect the magnetic flux that passes through the lower wall 45 of the valve seat 40 in the direction of the movable member 42, so that said magnetic flux passes through said movable member 42.

In this way, the air gap of the solenoid valve assembly 70 is changed so that, for a same electric current passing through the coil 30, that is, for a same power consumption, there is an “optimal” magnetic flux path and capable of attracting/repelling the movable member 42 with greater efficiency (intensity, speed) and reliability.

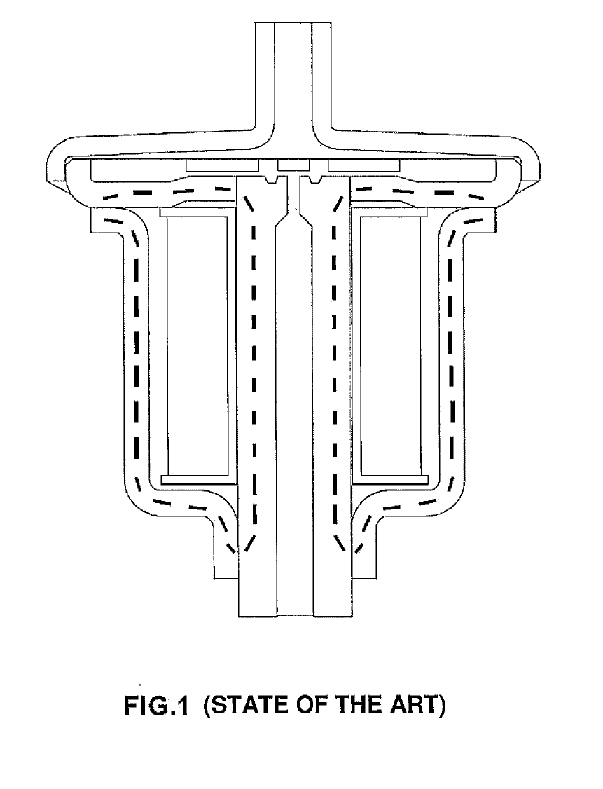

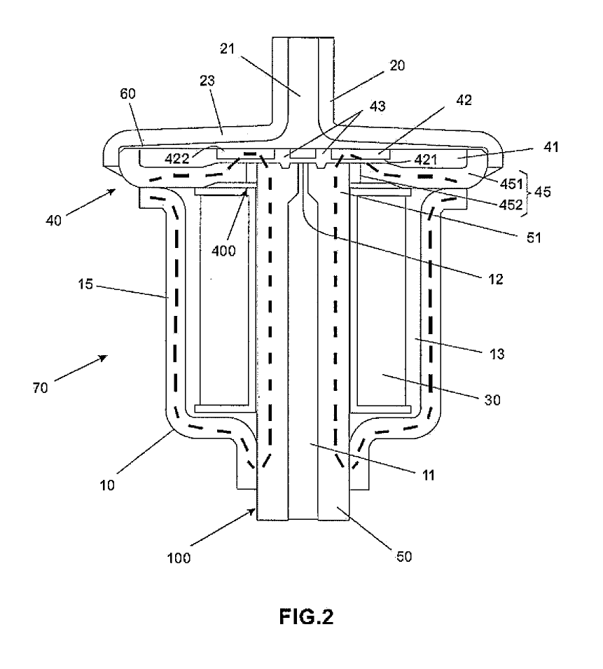

In this regard, and by way of comparison, it is pointed out that if the magnetic barrier portion 452 were not provided, the magnetic flux would travel a path as shown in dashed lines in FIG. 1. On the other hand, with the provision of said magnetic barrier portion 452 adjacent to the valve seat 40, the magnetic flux travels along a path as shown in dashed lines in FIG. 2.

Thus, it is highlighted that the provision of the magnetic barrier portion 452 is indispensable for the solenoid valve assembly 70 in accordance with the described arrangement, since the movable member 42 is longitudinally spaced—and substantially distant—from the main body and the coil 30.

According to the preferred embodiment of the present invention, the main body 10 has a cup shape, with a first hole 100 at its lower end which receives a tubular body 50, which defines the inlet path 11.

Preferably, the valve seat 40 also has a shape analogous to a cup, comprising a second hole 400 in its lower wall 45 so as to receive the upper end 51 of the tubular body 50.

Also, in a preferred manner, the secondary body 20 comprises a tubular shape including the flange portions 23 at its lower end so as to engage the valve seat 40, and also to define the stroke end of the movable member 42.

Thus, as can be seen from FIG. 2, according to the preferred embodiment of the present invention, the main body 10, the tubular body 50, the valve seat 40 and the secondary body 20 are axially aligned with each other.

Preferably, the magnetic barrier portion 452 defined in the valve seat 40 is a metallic ring, made of non-ferrous material. Alternatively, it may be an air ring. Another possibility, instead of a ring, would be possible the provision of arcuate segments circumferentially spaced from one another. In the case of choice of metallic material, a good option is the use of stainless steel due to its low magnetic permeability, low cost and ease of working (ductility, for example).

Further, and also in the case wherein the magnetic barrier portion 452 is a metallic ring, it is foreseen that said metallic ring has a thickness substantially equivalent to that of the lower wall 45, so that it is arranged adjacent thereto in such a way as to provide an extension thereof, in the region of the second hole 400.

Thus, in view of the above-described preferred features of the present invention, it will be appreciated that the airtight chamber 41 is finally defined by the valve seat 40, including its magnetic conducting portion 451 and its magnetic barrier portion 452, by the secondary body 20, as well as by the upper end 51 of the tubular body 50.

Preferably, the upper face 422 of the movable member 42 is associated with at least one return spring 60, of the flat spring type or the bundle of flat springs. Said return spring 60 is, preferably, seated against the flange portion 23 of the secondary body 20, adjacent the airtight chamber 41.

Obviously, in the case of the return spring 60 being a flat spring or bundle of flat springs associated with the upper face 422 of the movable member, said return spring 60 should have cooperating through-holes (not illustrated), that is, aligned with the through-holes 43 of the movable member 42 to ensure fluid communication between the airtight chamber 41 and the outlet path 21.

In this way, that is, with the magnetic barrier portion 452 defining part of the lower wall 45 itself of the valve seat 40, the return spring 60 being of the flat type or bundle of flat springs, and their arrangement occurring adjacent to the airtight chamber 41—and not being a helical spring arranged within the open chamber 13 defined by the main body 10, the present invention, in addition to achieving the objectives for which it is proposed, related to reliability, fast actuation and low power consumption, for example, it still provides a compact arrangement, able to be used in a variety of applications, including inside refrigeration compressors.

Thus, it is noted that neither the movable member 42 nor the magnetic barrier portion 452 nor the return spring 60 are arranged in the region surrounding or surrounded by the coil 30 or by the main body 10 housing said coil 30. In other words, both the movable member 42, the magnetic barrier portion 452 and the return spring 60 are arranged longitudinally spaced from the main body 10 and the coil 30.

It is further highlighted that, in a preferred manner, said through-hole 43 defined in the movable member 42 are radially spaced from the at least one inlet path 11.

As mentioned, said through-holes 43 provide fluid communication between the airtight chamber 41 and the outlet path 21, so that, in addition to being functional during normal operation in the solenoid valve assembly 70, they also show functional for pressure equalizing when it rises too much and unduly in the outlet path 21 in relation to the inlet path 11.

That is, if the downstream pressure of the movable member 42 is greater than the upstream pressure of the movable member 42, said movable member 42 could be forced to remain closed, inclusively overcoming the return force provided by return spring 60, a fact which is not desired, as mentioned above. Thus, said through-holes 43 allow the reflow of fluid from the outlet path 21 to the airtight chamber 41, however, since they are out of alignment—or radially spaced—from the inlet path 11, they do not considerably impair the flow of fluid therefrom.

Therefore, according to the features disclosed herein, the solenoid valve assembly 70 for flow control of the present invention is suitable for a variety of applications, including refrigeration compressors that require fast switching of the valve and a high number of switching cycles.

In addition, the proposed solenoid valve assembly 70 is also suitable for flow control in a high efficiency refrigeration system, such as that described in the document PI 06012981.

That is, it is also envisaged that a refrigeration system comprising a compressor 71 (preferably of the variable speed and/or multiple suction type), a condenser 72, an expansion device 73, an evaporator 74, an closed circuit 75 which fluidly and sequentially communicates the compressor 71, the condenser 72, the expansion device 73 and the evaporator 74, said expansion device 73 being positioned between the evaporator 74 and the condenser 72, may also comprise a solenoid valve assembly 70 for flow control, as that described, arranged between an outlet of the condenser 72 and an inlet of the expansion device 73.

Thus, since the expansion device 73 comprises a respective nominal expansion capacity and since the compressor 71 provides a flow of fluid along the closed circuit 75 comprising a nominal capacity of circuit flow, said solenoid valve assembly 70 can be modulated so that the fluid passing through the expansion device 73 is equivalent to the nominal expansion capacity. Therefore, even when the compressor 71 is operating at low capacity (low speed), the efficiency of the expansion device 73 can still be maintained, and consequently the efficiency of the refrigeration system as a whole.

It is important to emphasize that the above description has the sole objective of describing, in an exemplary manner, the particular embodiment of the invention in question. Therefore, it is clear that modifications, variations and constructive combinations of the elements that perform the same function substantially in the same manner to achieve the same results, remain within the scope of protection defined by the appended claims.

1. Solenoid valve assembly for flow control, said solenoid valve assembly including:
a main body and a secondary body;
a coil arranged within the main body;
at least one inlet path and at least one outlet path;
a valve seat physically associated to the main body and to the secondary body, in order to perform the interface between these, said valve seat, in combination with at least the secondary body, defining an airtight chamber;
at least one movable member arranged within the airtight chamber;
said at least one movable member comprising at least one ferromagnetic portion, so as to be attracted or repelled as a function of the magnetic field generated by the coil, so that the movable member is able to move;
said at least one inlet path communicating with the airtight chamber by at least one inlet opening;
said at least one movable member being co-operative with the at least one inlet opening in order to open or close it;
said solenoid valve assembly characterized by the fact that:
said valve seat comprises a lower wall including a magnetic conducting portion and a magnetic barrier portion;
said magnetic barrier portion being able to deflect the magnetic flux that passes through the lower wall of the valve seat towards the movable member.

2. Solenoid valve assembly for flow control, according to claim 1, characterized by the fact that the main body defines an open chamber.

3. Solenoid valve assembly for flow control, according to claim 2, characterized by the fact that the airtight chamber is longitudinally spaced from the open chamber defined by the main body.

4. Solenoid valve assembly for flow control, according to claim 1, characterized by the fact that the inlet path is defined in a tubular body that is physically associated to the main body and to the valve seat.

5. Solenoid valve assembly for flow control, according to claim 1, characterized by the fact that the magnetic barrier portion is a metallic ring, made of non-ferrous material.

6. Solenoid valve assembly for flow control, according to claim 1, characterized by the fact that the magnetic barrier portion is an air ring.

7. Solenoid valve assembly for flow control, according to claim 5, characterized by the fact that the metallic ring is made of stainless steel.

8. Solenoid valve assembly for flow control, according to claim 1, characterized by the fact that when the coil is de-energized, the movable member is spaced from the inlet opening, so as to maintain fluid communication between the inlet path and the airtight chamber.

9. Solenoid valve assembly for flow control, according to claim 1, characterized by the fact that the movable member includes a lower face that is able to seal the inlet opening and an upper face which is associated with at least one return spring.

10. Solenoid valve assembly for flow control, according to claim 9, characterized by the fact that the at least one return spring is a flat spring or a bundle of flat springs.

11. Solenoid valve assembly for flow control, according to claim 8, characterized by the fact that the return spring is seated against a flange portion of the secondary body.

12. Solenoid valve assembly for flow control, according to claim 1, characterized by the fact that the movable member comprises a discoid body.

13. Solenoid valve assembly for flow control, according to claim 1, characterized by the fact that the movable member comprises at least one through-hole, radially spaced from the at least one inlet path.

14. Refrigeration system comprising a solenoid valve assembly for flow control, the refrigeration system including:
at least one compressor;
at least one condenser;
at least one expansion device;
at least one evaporator;
a closed circuit which fluidly and sequentially communicates the at least one compressor, the at least one condenser, the at least one expansion device and the at least one evaporator;
the at least one expansion device comprising a respective nominal expansion capacity and being positioned between the at least one condenser and the at least one evaporator;
the compressor providing a flow of fluid along the closed circuit, wherein the closed circuit comprises a nominal capacity of circuit flow;
the solenoid valve assembly for flow control being positioned between an outlet of the at least one condenser and an inlet of the at least one expansion device;
the solenoid valve assembly for flow control being modulated so that the fluid passing through the expansion device is equivalent to the nominal expansion capacity;
said refrigeration system being characterized by the fact that the solenoid valve assembly for flow control is defined according to claim 1.
